(19) United States
(12) Patent Application Publication
(10) Pub. No.: US 2009/0296748 A1
(43) Pub. Date: Dec. 3, 2009

(54) LASER SYSTEMS AND MATERIAL PROCESSING

(75) Inventors: Mark Greenwood, Northhamptonshire (GB); Christopher Parsons, Warwickshire (GB); Mohammed Naeem, Derbyshire (GB)

Correspondence Address: GAUTHIER & CONNORS, LLP, 225 FRANKLIN STREET, SUITE 2300, BOSTON, MA, 02110, US

(73) Assignee: GSI GROUP LIMITED, Warwickshire (GB)

(21) Appl. No.: 12/505,003

(22) Filed: Jul. 17, 2009

Related U.S. Application Data
(63) Continuation of application No. PCT/GB2008/050033, filed on Jan. 17, 2008.

(30) Foreign Application Priority Data
Jan. 19, 2007 (GB) 0701056.4

(51) Int. Cl. H01S 3/30; H01S 3/094

(52) U.S. Cl. 372/6; 372/75

(57) ABSTRACT

A diode pumped laser is disclosed having a CW level and adapted to output one or more pulses having peak power greater than the CW level thereby to provide higher peak power for use in material piercing or penetrating operations without affecting diode lifetime.

### PRIORITY

The present application is a continuation application of and claims priority to Patent Cooperation Treaty Application No. PCT/GB2008/050033 filed Jan. 17, 2008, which claims priority to United Kingdom Patent Application No. 0701056.4 filed Jan. 19, 2007.

### TECHNICAL FIELD

This invention relates to laser systems and material processing. In particular, it relates to a system for piercing and cutting materials using a diode pumped laser or diode pumped fibre laser.

### BACKGROUND

Diode-pumped lasers use the outputs from laser diodes to pump a laser medium in a resonant chamber to create a laser beam. Recently, fibre lasers have become available that use combiners to direct power from laser diodes into the cladding layer of doped optical fibre provided with Bragg gratings and the diode energy provides the pumping energy to produce a laser output beam. A fibre laser is shown schematically in FIG. 1. Outputs from diodes 1 and 2 are applied through combining fibres 3 and 4 into the cladding layer of a fibre section 5 provided with Bragg gratings 6 and 7 and these act as pumping energy to pump the doped core within the laser section 5 to produce a laser beam L.

Fibre lasers are generally CW (continuous wave) lasers rather than being pulsed lasers. Currently, conventional CW fibre lasers have no peak power over a maximum average power capability. This is due to the peak power limitations of the diode pump sources used. Significant lifetime degradation is thought to occur if the junction temperature of a laser diode is increased during operation for any significant length of time of the order of that which would normally be useful for welding and cutting applications (e.g., typically of milliseconds and above).

Welding and cutting processes generally occur in the millisecond regime and involve the input of relatively large amounts of energy in a short period of time. That is, peak power is generally required to be much higher than the average power applied. The peak power helps to both enable and to speed up the process. Peak power at the beginning of the process is particularly useful as it is the initial coupling into the material which requires high intensities either to penetrate the material or to fully pierce it. After initial penetration or piercing, lower powers can be used successfully. For this reason, material processing which requires any amount of penetration or piercing of a material such as a metal material is often conventionally done using lamp pumped lasers where peak power is available without detriment to the pump source (e.g., the lamp) as opposed to with fibre lasers.

There remains a need, therefore, for a CW fibre laser that provides improved peak power operating characteristics such as providing a peak power that is above an average operating power.

### SUMMARY

The present invention arose in an attempt to provide an improved CW fibre laser with a peak power above average power capability but is applicable also to other types of diode pumped lasers.

In a first aspect, the invention comprises a CW diode pumped laser having a CW level and adapted to output one or more pulses having peak power greater than the CW level.

According to the present invention, in a further aspect, there is provided a diode pumped laser comprising one or more diodes suitable for providing pumping energy; means for power said diode; means for coupling energy from the diodes into a laser medium and means for generating a laser beam, wherein the system has an average CW power, the apparatus comprising means for powering the diodes for part of the time at least one peak power pulse greater than the average power.

Preferably, the power level for the time when the peak pulses are not generated is reduced compared to the nominal CW level to keep the average power level constant. Preferably, the laser is a fibre laser.

The peak pulses are most preferably up to about four to five times (preferably up to two times) the CW power level, although this is dependent upon damage threshold of material being processed so may be more than this.

The pulses most preferably have a pulse width of between about 0 and 20 μs, preferably between 5 and 20 μs and preferably about 10 μs. The duty cycle of the peak power pulse is preferably 10% or less.

Most preferably, the apparatus is such that to produce peak power pulse greater than the CW level for a period of time sufficient to penetrate or pierce a material being processed and then to use CW power.

In a further aspect, there is provided a method of processing a material using a diode pumped CW laser, comprising: generating a laser beam at CW level; superimposing laser pulses above CW level having a peak power greater than the CW level, at a duty cycle, and repeating the pulses for a period time sufficient to penetrate or pierce the material. The pulses are preferably supplied so that the average power is substantially the CW level (i.e. the nominal CW level of the diodes/laser).

The invention further provides a laser apparatus, a diode driving apparatus or a method of material processing, including any one or more of the novel features, steps, or combinations of features or steps herein described.

The invention further provides a method of operating a CW laser diode, comprising generating CW level, and superimposing one or more pulses having peak power greater than the CW level for a pulse width, amplitude and duty cycle which substantially unaffects lifetime of the diode. Thus, laser diodes may be used to process materials directly without pumping a laser.

The invention further provides a method of operating a diode CW with modulation superimposed which enhances the material processing capability of a laser it is optically pumping (or of the diode ensemble itself) without affecting, or derating the lifetime of the diode.

Embodiments of the invention utilise so-called CW diodes which up to now have always been operated only at CW level. ‘Quasi-CW’ diodes are available which have peak power capability but only at reduced duty cycle. These operate at a very low duty cycle and have very low average power.

### BRIEF DESCRIPTION OF THE DRAWINGS

Embodiments of the invention will now be described, by way of example only, with reference to the accompanying schematic drawings, in which:

FIG. 1 shows a fibre laser;

FIG. 2 shows a pulse profile;

FIG. 3 shows a stream of pulses;

FIG. 4 shows a chart of piercing time vs spike width;

FIG. 5 shows a current modulator;

FIG. 6 shows a current modulator;

FIG. 7 shows a diagram of pulse width against COD level;

FIG. 8 shows a laser diode; and

FIGS. 9 to 13 show pulse diagrams.

The drawings are shown for illustrative purposes only.

### DETAILED DESCRIPTION

The following description is of a diode pumping arrangement for a fibre laser. However, the invention is equally applicable to other types of diode pumped lasers.

As is described above, with conventional lamp pumped lasers it is relatively easy to generate pumping pulses having substantially higher peak power than average CW power and this is useful for materials processing application where a workpiece must first be penetrated or pierced before cutting. The high peak power pulses enable the initial piercing and then the welding can be carried on at CW level.

With conventional diode arrangements, this has not heretofore been possible. The diodes themselves have not been able to withstand peak power pulses of the durations required to penetrate or pierce the material. The diodes used in embodiments of the invention are generally ‘CW’ diodes that are used, conventionally, only in CW mode applications.

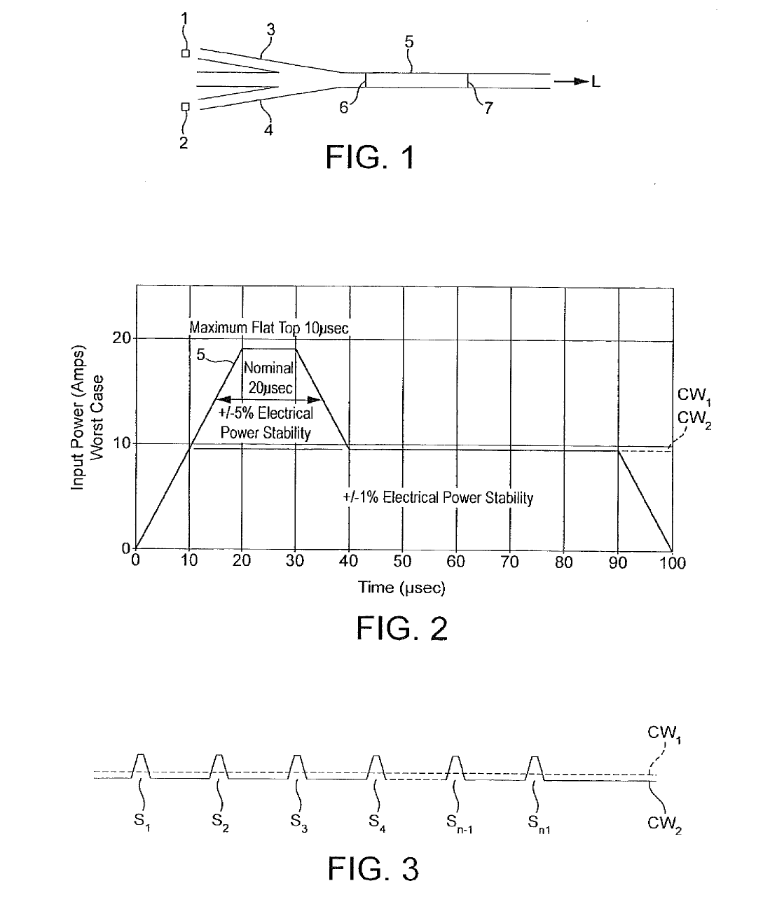

In embodiments of the present invention, relatively short length peak power pulse greater than the CW level (typically of the order of about two times the average CW level) are generated. It has been found that this does not noticeably affect diode life. As is shown in FIG. 1, pumping energy from one or more laser diodes 1, 2 are used as pumping energy for a fibre laser. Previously, for CW operation, the diodes were powered to produce a CW output level CW₁ (FIG. 2). As shown in the figure, this is nominally around 10 amps although this may vary with the type of laser diodes used.

In an embodiment of the invention, the diodes are pulsed with a waveform superimposed over the CW level to have an initial spike S whose peak value in this example is around 19 amps but in practice more normally it may be up to about two times the average power CW₁ or more or less than this. It has been found that using peak powers of up to about two times the level of CW₁ and having a peak value of up to about 10 μs does not detrimentally affect the lifetime of the diode. In practice, peak duration of greater than this may be found to also not affect the lifetime and peak powers of greater than two times CW₁ might also be useable. The peak power can be any value up to this.

As shown in FIG. 2, in a typical example, the diodes are powered to a peak power of just under two CW₁ peak power for a pulse width of around 10 μs. After this period, the current applied to the diodes and therefore the diode output power, is reduced down to a level a little below CW₁, that is CW₂. The value of CW₂ is reduced slightly compared to the rated average power CW₁ so that the average power produced by the diode is kept constant. Thus, the level CW₂ will normally (but not always) be a little less than CW₁, such that the average power including the peak and the CW level remains at the same level as it would be if the diodes were driven at a constant level of CW₁.

The pulse shown in FIG. 2 has a peak for around 10 μs and then the CW level for around 100 μs. Thus, the duty cycle is around 10%. Note that this is a worse case scenario showing significant rise and fall times. In practice, one would try to reduce these times. In preferred embodiments of the invention, the duty cycle is kept relatively low, say to less than or equal to 10%, again to preserve the lifetime of diodes and also to make sure than the CW power CW₂ does not need to be reduced too much beyond the nominal CW power CW₁. Although FIG. 2 shows a CW pulse of around 100 μs upon which the spike S is superimposed, in practice the CW level may be continuous.

Note that FIG. 2 shows input power to the diodes. In practice, the laser outputs follows this. Clearly, if a plurality of diodes are used, as will be most common, to pump the laser, then these should be powered in synchronism.

In embodiments of the invention, peak pulses as shown in FIG. 2 are superimposed over the top of the CW power at the start of a materials processing operation and for a period sufficient to penetrate or pierce the material. Piercing time will of course depend upon the type of material and the thickness. In experiments with a 200 μm thick pierce of stainless steel, the piercing will be of the order of milliseconds, perhaps, say, 10 to 15 ms. This would therefore require approximately 100 to 150 peak power pulses S. Such a regime is shown in FIG. 3, where spikes S₁, S₂, S₃, S₄, . . . Sₙ₋₁, Sₙ are superimposed over a CW level, CW₂. The diagram also shows the nominal CW level, CW₁ if the spikes were not used. The affect of superimposing the spikes of higher peak power is to increase the output power of the laser diodes and therefore the output power of the laser.

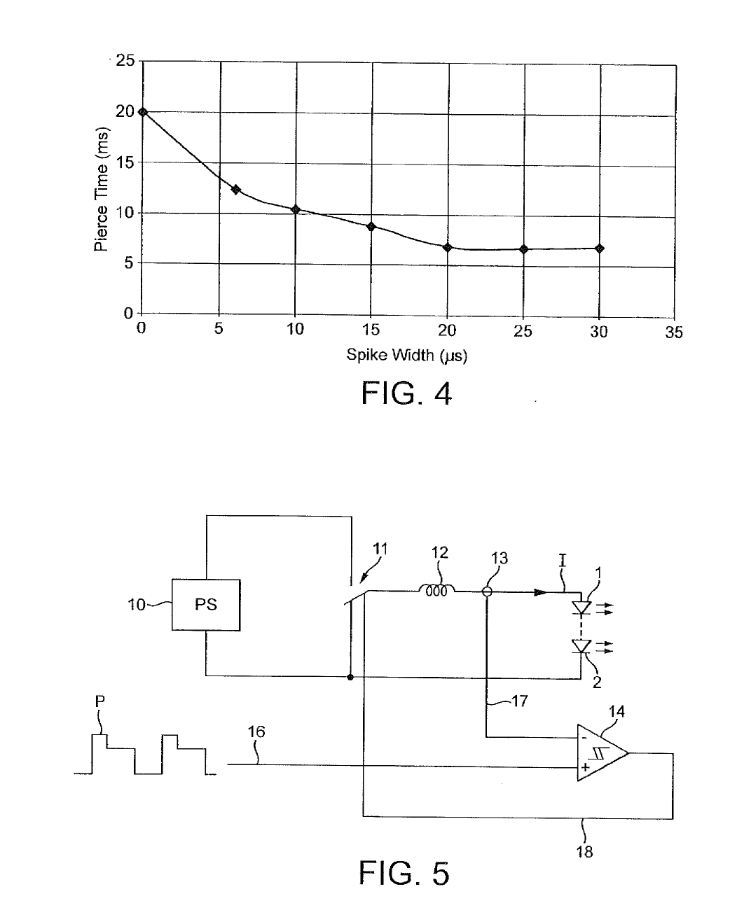

FIG. 4 shows piercing times to pierce the workpiece described above, i.e. a workpiece of stainless steel of around 250 μm in depth, using a 100 W single mode fibre laser. An AgiLent™ 33220A waveform generator was used to control pulses. Oxygen assist gas was used.

Using just CW output, the piercing time is around 20 ms. A spike width of 6 Us reduces this time down to around 12.4 ms. A spike width of 10 μs reduces the piercing time down to just over 10 ms. Increasing the spike width up to 15 and 20 μs and 25 μs also reduces the piercing time (down to 6.7 ms with a 25 μs pulse) but once the spike width exceeds about 20 μs or about 25 μs the piercing time was not significantly improved further. Thus, from this result it can be seen that, at least for this material, there is little or no advantage having a spike width more than 20 μs or 25 μs and so the optimum spike width is probably somewhere between around 5 to 25 μS. In a preferred embodiment, this is about 10 μs. An initial spike having width of 10 μs, and peak value approximately twice the CW level, effectively halves the piercing time. This is a significant advantage.

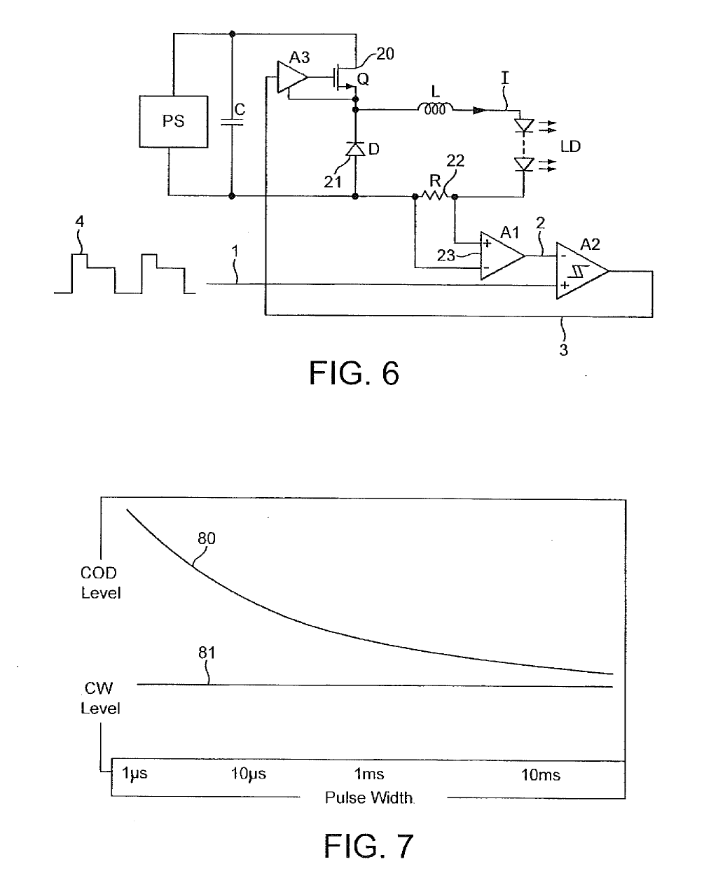

FIGS. 5 and 6 show the current modulators that may be used to power the laser diodes of the present invention. Referring to FIG. 5, laser diodes 1, 2 are powered by a DC power supply 10 which has an output voltage somewhat greater than the maximum voltage drop across the laser diodes 1, 2 at maximum current. The circuit includes a fast electronic change over switch 11, an inductor 12, a current sensor 13 and a comparator 14 with hysteresis. 16 is an input signal representative of the desired laser diode current and 17 is a feedback signal from the current sensor 13 representing the actual laser diode current. The comparator produces a control signal 18 controlling switch 11. P shows schematic desired output waveforms.

The desired input signal 1 is compared in the comparator with a feedback signal 17 from the current sensor 13. When the input signal 16 is greater than the feedback signal 17, a signal is generated by the comparator 14 over line 18 and switch S is actuated to connect the power switch 10 to the inductor 12. Current therefrom flows through the circuit 10, 12, 13, 1, 2 and back to the power supply 10. Since the voltage of the power supply PS is greater than the voltage drop across the laser diodes 1 and 2 the current across the diodes increases and this increases their output.

When the feedback signal 17 is greater than the input signal 16, then the switch S connects the inductor to the laser diodes 1 and 2 and current I flows around the circuit 12, 13, 1, 2 and back through 12 (i.e., avoiding the power supply 10). The current I therefore reduces.

This process continues with the switch S switching between the two positions and current I alternately rising and falling, with an average value determined by the input signal 16. The spike S depends on the power supply and laser diode voltages, the value of inductor 12 and the hysteresis of comparator 14.

FIG. 6 shows a more detailed circuit. In this case, the change-over switch comprises a MOSSFET 20 and a diode 21. The current sensor comprises a resistor 22 and an amplifier 23. The circuit works fundamentally in the way described with reference to FIG. 5.

Embodiments of the invention, in addition to performance enhancements, also provide cost benefits as a laser using the invention effectively acts as though were a higher power CW laser than is it were operated conventionally, avoiding the cost of purchasing a more expensive CW laser of normally higher power.

Some examples are shown below, in tables A and B, where ‘fibre piece’ means a regime according to the invention in which peak power greater than CW are used.

TABLE A
100 μm thick Al foil

| | Average | Peak | Cutting | |
|---|---|---|---|---|
| | power | Power | speed | |
| Laser output | (W) | (W) | (m/min) | Comments |
| CW | 50 | — | 1.0 | No cut |
| CW | 75 | — | 1.0 | Dross free cut |
| Fibre piece | 50 | 120 | 1.2 | Dross free cut |
| Fibre piece | 50 | 150 | 1.3 | Dross free cut |
| Fibre piece | 50 | 170 | 1.4 | Dross free cut |
| Fibre piece | 50 | 200 | 1.6 | Dross free cut |

TABLE B
250 μm thick copper foil

| | Average | Peak | Cutting | |
|---|---|---|---|---|
| | power | power | speed | |
| Laser output | (W) | (W) | (m/min) | Comments |
| CW | 50 | — | 0.8 | Slightly drossy cut |
| CW | 100 | — | 1.5 | Dross free cut |
| Fibre piece | 50 | 100 | 1.6 | Dross free cut |
| Fibre piece | 50 | 150 | 1.8 | Dross free cut |
| Fibre piece | 50 | 200 | 2.0 | Dross free cut |

As shown, where regimes according to the invention are used, significantly increased cutting speed and reduction in dross occurs. Kerf width can also be smaller. By using a peak power of 200 W for example, cutting speed for a laser normally rated at 50 w CW (average power) may be 60% increased.

In further tests with the technique of the present invention, there was enhancement in the cutting speed for all the materials tested compared to CW operation, especially for highly reflective materials, i.e.
250 μm thick 304 stainless steel; 38% increase
100 μm thick aluminium foil; 160% increase
250 μm thick copper foil; 150% increase
100 μm thick brass foil; 63% increase
350 μm thick brass foil; 40% increase
250 μm thick Si wafer; 13% increase
650 μm thick ceramic; 30% increase
700 μm thick Zn-coated steel; 8% increase

In a variation, one or more laser diodes, powered to generate pulses as described, may be used directly, to process material, without pumping a laser. That is, a method of operating a CW laser diode, comprising generating CW level, and superimposing one or more pulses having peak power greater than the CW level for a pulse duration, amplitude and duty cycle which substantially unaffects lifetime of the diode.

The pulse may have any of the parameters or characters disclosed or suggestion herein.

Material processing operation may be cutting, welding, weld penetrating, piercing or any other processing operation done by a laser, or directly by laser diodes.

In embodiments of the invention, diodes may be operated at high peak power for any pulse duration and/or duty cycle that does not substantially affect diode lifetime.

Embodiments of the invention provide, amongst other benefits:
faster piercing at the beginning of the cut
faster cutting speeds compare to just CW output
improved coupling in highly reflective materials, i.e. Al and Cu based alloys
improved cutting quality, i.e. reduced dross, etc
increased cycle time

The COD (catastrophic optical damage) threshold of a diode changes with pulse length. This is schematically shown in FIG. 7 where the COD level 80 is plotted against pulse width. The CW level 81 is also shown.

As the pulse width increases, then the COD level nears the CW level. For lower pulse widths the COD level is considerably greater than the CW level. For a duty cycle of about 10% or less (which the usual method for measuring COD threshold changes with pulse length) the COD threshold can be two to three times that of the CW level.

Clearly, from the figure, very short pulses lead to much higher COD level but these have little effect in materials processing application due to the very low energy levels associated with the pulse. However, a high energy, too long pulse will lead to COD. It has been found that the optimum position for material interaction is therefore in the 10 its regime. This is why an optimum value of around 100 s is chosen in preferred embodiments of the present invention, although other values still provide benefit.

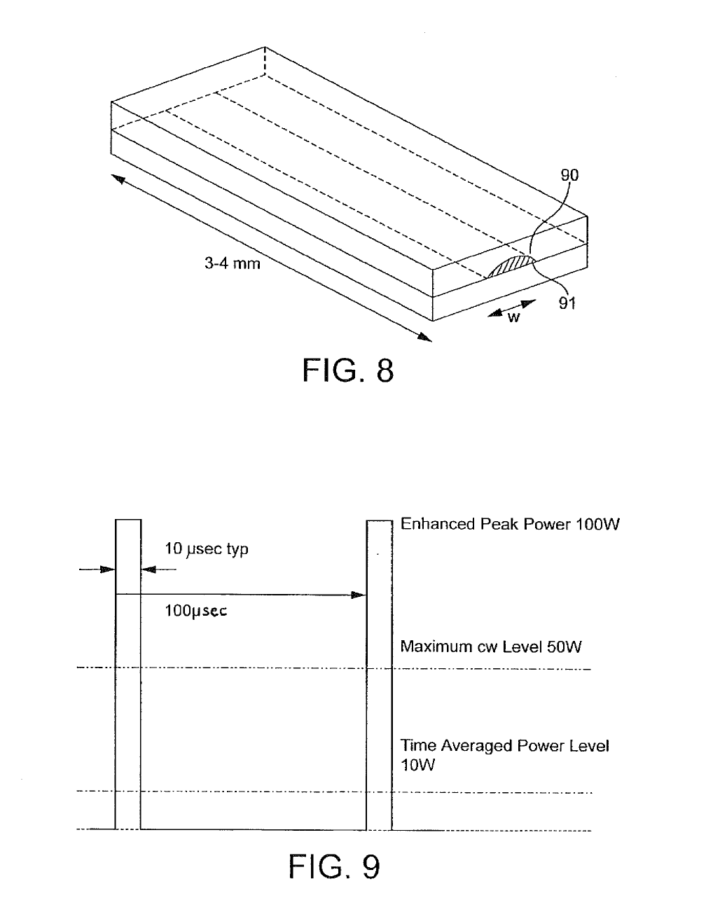

FIG. 8 shows schematically a laser diode. This includes an active region 90 and laser radiation is emitted from the face 91 of this, in well known manner. A typical emitter width W is 100 μm.

Many processes require low average powers but higher peak powers, say two to tens peak power. With diodes with no peak over average capability, then many more diodes are need to achieve the peak power and this is therefore expensive. Two key factors affect diode average power: Firstly, heating effects due to average power and hence cooling issues for device temperature limit, for good lifetime. Secondly, the maximum power of the output facet (milliwatts per μm max power limit) before COD occurs.

As such devices are very small, typically around 4 mm by 1 mm by 400 μm, then increases in power dissipation become difficult to handle and average power heating limits the output power of the device. The emitter width (which is typically 100 μm) therefore sets the maximum peak power based upon the milliwatts/μm limit. In some embodiments of the invention, if this active region 90 is made wider then this has little effect on the average power thermal performance (due to the point source nature of the heat) but maximum power (based upon milliwatts/μm limit) theoretically increases. Thus, if the device active region is increased up to 200 μm or about 200 μm, then the maximum peak power should theoretically double. In other embodiments of the invention, this might be increased even further to any value up to 400 μm in width or even more. The maximum width might be effected by effects such as filamentation.

Therefore, for a typical stencil or stent cutting application an increase from 100 μm to 200 μm is currently preferred, but other values may be used.

For a typical stencil or stent cutting application, average powers of, say, 10 to 50 W may be needed, but ideally with peak powers of greater than 100 W. With current CW lasers, typically a 100 W laser would be needed to be used and this would need to be modulated accordingly. With a device according to the present invention using 100 μm emitters, then a 50 W laser could be used (see tables and description above) and, even better, using 200 μm emitters, then potentially a 30 W laser could be used. This can reduce size, weight and cost even further. At least one diode may have such a broad stripe.

Note that in embodiments of the invention, the diodes need not necessarily be operated at the maximum (or near maximum) CW level between the pulses. Between the pulses they might be operated at a level lower or considerably lower than CW, or even zero. In an extreme regime, the diodes are simply pulsed with the high pulses for a period (typically 10 μs) at a particular duty cycle (say 10%) and return to zero between these pulses, as shown in FIG. 9. This provides a lower average power, high peak power regime. In this case, for a laser of maximum 50 W CW, the peak power is 100 W and average power 10 W, at 10% duty cycle.

Also, in embodiments of the invention, the diodes may be operated at a plurality of levels (not just CW and pulse). It may be operated, for example, in a cycle which has a pulse at greater than CW level for a period, then at a level less than CW for a period then at zero for the remainder of the cycle. This can then repeat for as long as is necessary.

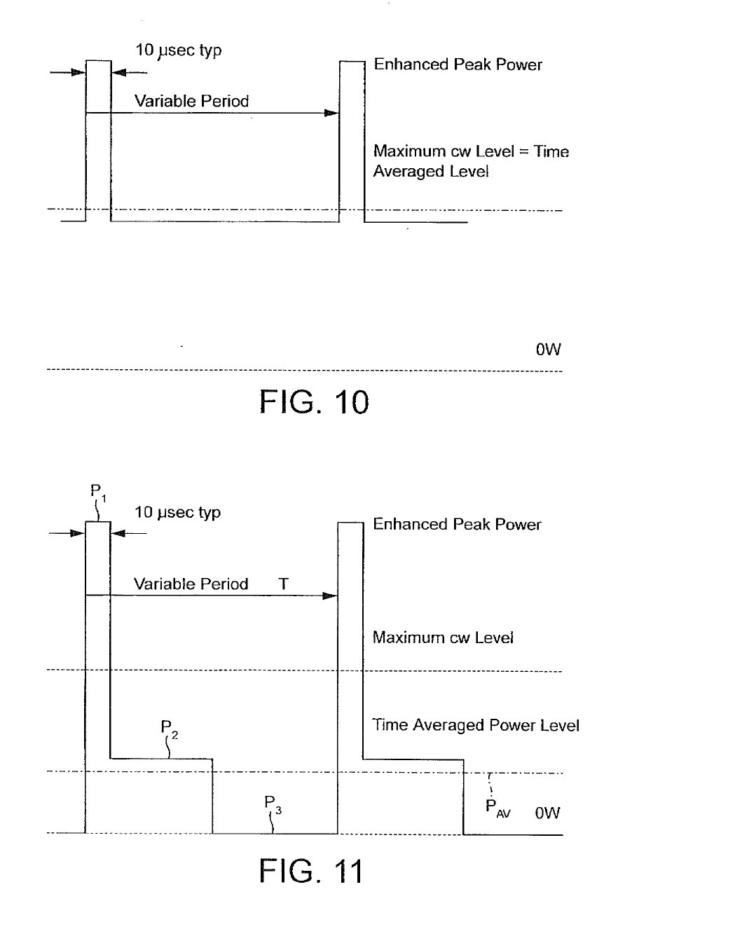

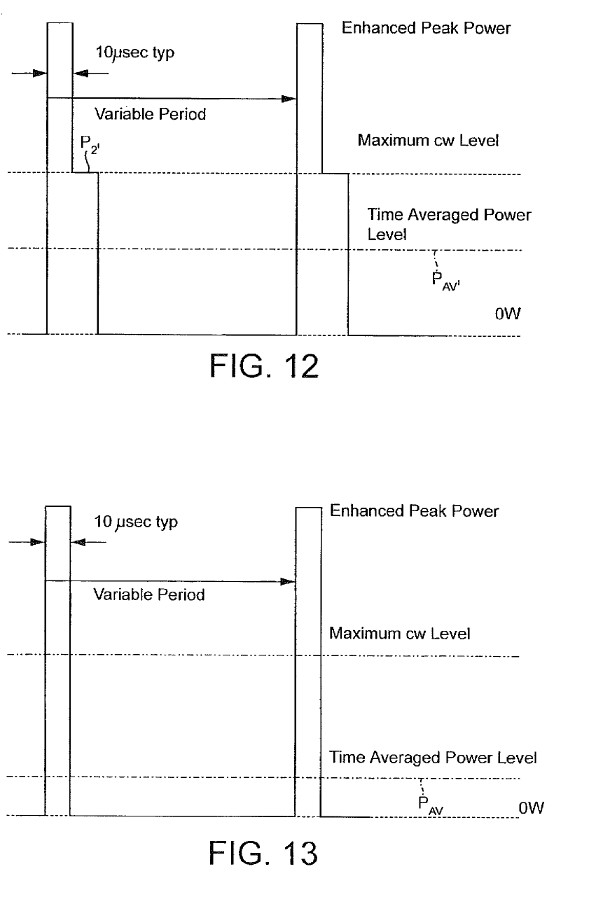

FIG. 10 shows a regime as previously. FIG. 11 shows one in which, after each high power pulse P₁, operation is at a lower level P₂ for a predetermined time, then zero (P₃) for the remainder of a variable period T. This produces Peak Power P₁ and True average power level P_{AV}. FIG. 12 shows P₂¹ being less than P₂ in FIG. 13 so P_{AV}¹ is higher. FIG. 13 shows a regime where the level reduces to zero between the high pulses—leading to a high peak power—low average power regime.

Those skilled in the art will appreciate that numerous modifications and variations may be made to the above disclosed embodiments without departing from the spirit and scope of the invention.

What is claimed is:

1. A diode pumped CW laser having a CW level and adapted to output one or more pulses having peak power greater than the CW level.

2. A diode pumped laser as claimed in claim 1, wherein the pulse has peak power up to damage threshold of a diode, preferably up to three times CW level and preferably up to two times CW level.

3. A diode pumped laser as claimed in claim 1, where the peak power pulses are provided at a duty cycle of approximately 10% or less.

4. A diode pumped laser as claimed in claim 1, wherein the peak power pulses each have a pulse width of around 0 to 25 μs, preferably 5 to 25 μs.

5. A diode pumped laser as claimed in claim 4, wherein the pulse width is around 10 μs.

6. A diode pumped laser as claimed in claim 1, wherein the laser has a nominal CW level and is pulsed to peak power pulses superimposed over a CW level which is less than that of the nominal CW level so as to maintain average power constant.

7. A diode pumped laser as claimed in claim 1, wherein at least one laser diode used for pumping is a broad stripe laser diode having an emitting area of width greater than 100 μm.

8. A laser as claimed in claim 7, wherein the width is about 200 μm.

9. A diode pumped laser comprising one or more diodes suitable for providing pumping energy;
means for powering said diodes;
means for coupling energy from the diodes into a laser medium; and
means for generating a laser beam therefrom; wherein the system has an average CW power, the apparatus comprising means for powering the diodes for part of the time at least one peak power pulse greater than the average CW power.

10. A diode pumped laser as claimed in claim 9, wherein for the time when the peak pulses are not generated the CW level is reduced compared to a nominal CW level for the laser to keep the average power constant.

11. A diode pumped laser as claimed in claim 9, wherein the laser is a fibre laser.

12. A diode pumped laser as claimed in claim 9, wherein the peak power level of the pulses is up to about two or three times the CW level.

13. A diode pumped laser as claimed in claim 10, wherein the peak power pulse has a pulse width of between 0 and 25 μs.

14. A laser as claimed in claim 13, wherein the pulse width is about 10 μs.

15. A laser as claimed in claim 10, wherein at least one diode has an emitting area of width greater than 100 μm.

16. A laser as claimed in claim 15, wherein the width is around 200 μm.

17. A laser as claimed in claim 9, wherein the duty cycle of the peak power pulse to CW level is up to about 10%.

18. A laser as claimed in claim 9, wherein the pulse regime is such that the lifetime of the diodes is substantially unaffected.

19. A method of processing a material using a diode pumped CW laser, said method comprising the steps of:
generating a laser beam at a CW level; and
superimposing one or more laser pulses above CW level having a peak power greater than the CW level at a duty cycle and repeating the pulses for a period time sufficient to penetrate or pierce the material.

20. A method as claimed in claim 19, wherein, after the material is penetrated or pierced to a desired level, the laser output is continued at the CW level.

21. A method as claimed in claim 19, where the laser has a nominal CW level and the operating CW level, with CW pulses superimposed, is reduced compared to the nominal level so as to keep the average power output constant.

22. A method as claimed in claim 19, wherein the peak pulses are up to two times the CW power level.

23. A method as claimed in claim 19, wherein the CW pulses have a peak power for a duration of between about 0 and 20 μs.

24. A method as claimed in claim 23, wherein the pulse width of the peak pulses is up to about 10 μs.

25. A method as claimed in claim 19, wherein the duty cycle of the peak power pulse to CW power is up to about 10%.

26. A method as claimed in claim 19, which is a welding, weld penetrating or any other materials processing operation.

27. A method as claimed in claim 19, wherein at least one diode has an emitting area of width greater than 100 μm.

28. A method as claimed in claim 27, wherein the width is around 200 μm.

29. A method of operating a CW laser diode, said method comprising the steps of generating CW level, and superimposing one or more pulses having peak power greater than the CW level for a pulse duration, amplitude and duty cycle.

30. A method as claimed in claim 29, wherein the average level output is substantially the nominal CW level of the diode.

31. A method as claimed in claim 29, used to process a material.

32. A method as claimed in claim 29, used to pump a laser medium.

33. A method as claimed in claim 29, wherein the lifetime of the diode is substantially unaffected.

34. A CW laser, pumped by a method as claimed in claim 29.
